(19) United States
(12) Patent Application Publication
(10) Pub. No.: US 2006/0062107 A1
(43) Pub. Date: Mar. 23, 2006

(54) Optical disc apparatus

(75) Inventor: Hirofumi Iwasa, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 11/221,868

(22) Filed: Sep. 9, 2005

(30) Foreign Application Priority Data
Sep. 9, 2004 (JP) P2004-262549

(51) Int. Cl. G11B 7/00

(52) U.S. Cl. 369/44.32; 369/53.19

(57) ABSTRACT

When an optical disc is set in an optical disc apparatus, appropriate tilt angles of a pickup head with respect to this optical disc are detected at two detecting positions at inner and outer peripheral sides. The tilt angles detected this time is definitively set corresponding to the inner and outer peripheral sides. The tilt angles corresponding to other regions are provisionally set according to the tilt angles detected at the two detecting positions. When the pickup head seeks the region, the tilt angle corresponding to which is provisionally set, or when the pickup head temporally stops at the region, the tilt angle corresponding to which is provisionally set, the tilt angle of the reading unit at this position is detected. Then, the tilt angle detected this time is definitively set corresponding to this region.

### BACKGROUND OF THE INVENTION

1. Field of the Invention

This invention relates to an optical disc apparatus having a tilt control function of controlling the optical axis of laser light, which is irradiated onto an optical disc such a CD or a DVD, to be perpendicular to a recording surface of the optical disc.

2. Description of the Related Art

Hitherto, optical disc apparatuses configured to read data recorded on optical discs, such as a CD and a DVD, and to record data on optical discs have been generally widely used. The optical disc apparatuses read the recorded data from and records data onto optical discs by irradiating laser light onto optical discs. Data can be record at a higher density on the DVD, as compared with the CD. Thus, the DVD is smaller in track pitch and pit size than the CD. Additionally, optical discs such as a BD (Blue-ray Disk), which are higher in data recording density than the DVD, have been being developed.

Meanwhile, in a case where the optical axis of laser light irradiated from a pickup head is not perpendicular to a recording surface of an optical disc, coma aberration occurs on laser light focused onto the recording surface of the optical disc. Thus, a laser light spot formed on the recording surface of the optical disc is deformed. This results in increase in the possibility of failing in reading and recording data. Thus, an optical disc apparatus having a tilt control function of controlling the optical axis of laser light, which is irradiated from a pickup head, to be perpendicular to a recording surface of an optical disc has been proposed. As is publicly known, a tilt control operation is a control operation of tilting a pickup head or an objective lens so that the optical axis of laser light irradiated from the pickup head becomes perpendicular to a recording surface of an optical disc. Incidentally, an angle, at which the pickup head or the objective lens is tilted, is referred to as a tilt angle. For example, JP-A-2004-95040 and JP-A-2003-141761 disclose optical disc apparatuses configured so that when an optical disc is set therein, an optimum tilt angle is detected at each of many detecting positions arranged in a radial direction of this optical disc, and that a tilt angle corresponding to an interval between each pair of adjacent detecting positions arranged in a radial direction is estimated by first-order approximation using the tilt angles respectively detected at the corresponding pair of adjacent detecting positions, and that the pickup head or the objective lens is tilted according to a result of the estimation.

### SUMMARY OF THE INVENTION

However, because the apparatuses disclosed in JP-A-2004-95040 and JP-A-2003-141761 are configured to detect an optimum tilt angle at each of many detecting positions arranged in a radial direction when an optical disc is set therein, these apparatuses have problems that it takes long time to become ready for starting to read and record data from and onto an optical disc after the optical disc is set therein, and that users' operability is degraded.

An object of the invention is to provide an optical disc apparatus enabled to enhance users' operability thereof by reducing a time required to become ready for starting to read and record data from and onto an optical disc after the optical disc is set therein.

To solve the problems, according to the invention, there are provided the following optical disc apparatuses.

A first aspect of the invention provides an optical disc apparatus including: a reading unit adapted to read data recorded on an optical disc set in a main body of the optical disc apparatus by irradiating laser light onto the optical disc; a tilt-angle detecting unit adapted to detect a tilt angle of the reading unit with respect to the optical disc set in the main body; a setting unit adapted to detect, when the optical disc is set, the tilt angle of the reading unit at a plurality of predetermined detecting positions arranged in a radial direction of the optical disc, and adapted to set the tilt angle of the reading unit, which corresponds to each of the positions arranged in the radial direction of the set optical disc; and a tilt-angle control unit adapted to control the tilt angle of the reading unit according to the tilt angle set corresponding to a reading position, at which the reading unit reads data from the optical disc, by the setting unit; wherein when the optical disc is set, tilt angles of the reading unit are detected by the tilt angle detecting unit at two detecting positions respectively predetermined at an inner peripheral side and an outer peripheral side of the optical disc; the setting unit definitively sets the detected tilt angle corresponding to regions, in which the detecting positions respectively predetermined at the inner peripheral side and the outer peripheral side are present, among a plurality of regions, into which the optical disc is divided in the radial direction thereof; the setting unit provisionally sets the tilt angle corresponding to each of the other regions according the tilt angles detected by the tilt angle detecting unit at the detecting positions at the inner peripheral side and the outer peripheral side, respectively; when seeking the region, the tilt angle corresponding to which is provisionally set, the tilt angle of the reading unit is detected at a seeking position by the tilt angle detecting unit; and the setting unit definitively sets the tilt angle detected at the seeking position corresponding to the sought region.

With this configuration, when an optical disc is set in the apparatus, an appropriate tilt angle of the reading unit with respect to this optical disc is detected by the tilt angle detecting unit at each of the two detecting positions determined at the inner peripheral side and the outer peripheral side thereof. The setting unit definitively sets a tilt angle detected this time corresponding to a region, in which the two detecting positions respectively predetermined at the inner peripheral side and the outer peripheral side are present, among a plurality of regions, into which the optical disc is divided in a radial direction thereof. Meanwhile, the setting unit provisionally sets the tilt angle corresponding to each of the other regions according the tilt angles detected by the tilt angle detecting unit at the detecting positions at the inner peripheral side and the outer peripheral side, respectively. For instance, a tilt angle obtained by the first-order approximation using the tilt angles detected at the two detecting positions determined at the inner peripheral side and at the outer peripheral side is provisionally set corresponding to each of the other regions. Further, when seeking the region, the tilt angle corresponding to which is provisionally set, a tilt angle of the reading unit is detected at this seeking position by the tilt angle detecting unit. The setting unit definitively sets the tilt angle detected this time corresponding to this region.

Thus, the optical disc apparatus of the invention is configured so that when an optical disc is set therein, an appropriate tilt angle of the reading unit with respect to the set optical disc is detected at each of the two detecting positions determined at the inner peripheral side and the outer peripheral side thereof. Consequently, the optical disc apparatus can reduce the time required to become ready for starting to read and record data from and onto an optical disc after the optical disc is set therein. Users' operability can be enhanced. The tilt angle of the reading unit is detected at the seeking corresponding to the region, the tilt angle corresponding to which has been provisionally set. The tilt angle detected this time is definitively set corresponding to this region. Thus, the tilt angle of the reading unit, which is detected at each of the positions arranged in the radial direction of the optical disc, corresponding to each of the regions, into which the optical disc is divided in the radial direction, can be controlled with good accuracy. Consequently, the tilt angles corresponding to the positions arranged in the radial direction of an optical disc can be controlled with good precision.

A second aspect of the invention provides an optical disc apparatus including: a reading unit adapted to read data recorded on an optical disc set in a main body of the optical disc apparatus by irradiating laser light onto the optical disc; a tilt-angle detecting unit adapted to detect a tilt angle of the reading unit with respect to the optical disc set in the main body; a setting unit adapted to detect, when the optical disc is set, a tilt angle of the reading unit at a plurality of predetermined detecting positions arranged in a radial direction of the optical disc, and adapted to set the tilt angle of the reading unit, which corresponds to each of the positions arranged in the radial direction of the set optical disc; and a tilt-angle control unit adapted to control the tilt angle of the reading unit according to the tilt angle set corresponding to a reading position, at which the reading unit reads data from the optical disc, by the setting unit; wherein when the optical disc is set, the tilt angles of the reading unit are detected by the tilt angle detecting unit at two detecting positions respectively predetermined at an inner peripheral side and an outer peripheral side of the optical disc; the setting unit definitively sets the detected tilt angle corresponding to regions, in which the detecting positions respectively predetermined at the inner peripheral side and the outer peripheral side are present, among a plurality of regions, into which the optical disc is divided in the radial direction thereof; the setting unit provisionally sets the tilt angle corresponding to each of the other regions according the tilt angles detected by the tilt angle detecting unit at the detecting positions at the inner peripheral side and the outer peripheral side, respectively; when temporarily stopped in the region, the tilt angle corresponding to which is provisionally set, the tilt angle of the reading unit is detected at a temporary stop position by the tilt angle detecting unit; and the setting unit definitively sets the tilt angle detected at the temporary stop position corresponding to the region in which the reading unit is temporarily stopped.

With this configuration, when an optical disc is set in the apparatus, an appropriate tilt angle of the reading unit with respect to this optical disc is detected by the tilt angle detecting unit at each of the two detecting positions determined at the inner peripheral side and the outer peripheral side thereof. The setting unit definitively sets a tilt angle detected this time corresponding to a region, in which the two detecting positions respectively predetermined at the inner peripheral side and the outer peripheral side are present, among a plurality of regions, into which the optical disc is divided in a radial direction thereof. Meanwhile, the setting unit provisionally sets the tilt angle corresponding to each of the other regions according the tilt angles detected by the tilt angle detecting unit at the detecting positions at the inner peripheral side and the outer peripheral side, respectively. For instance, a tilt angle obtained by the first-order approximation using the tilt angles detected at the two detecting positions determined at the inner peripheral side and at the outer peripheral side is provisionally set corresponding to each of the other regions. Further, when temporarily stopping in the region, the tilt angle corresponding to which is provisionally set, a tilt angle of the reading unit is detected at this temporary stop position by the tilt angle detecting unit. The setting unit definitively sets the tilt angle detected this time corresponding to this region.

Thus, the optical disc apparatus of the invention is configured so that when an optical disc is set therein, an appropriate tilt angle of the reading unit with respect to the set optical disc is detected at each of the two detecting positions determined at the inner peripheral side and the outer peripheral side thereof. Consequently, the optical disc apparatus can reduce the time required to become ready for starting to read and record data from and onto an optical disc after the optical disc is set therein. Users' operability can be enhanced. The tilt angle of the reading unit is detected at the temporary stop corresponding to the region, the tilt angle corresponding to which has been provisionally set. The tilt angle detected this time is definitively set corresponding to this region. Thus, the tilt angle of the reading unit, which is detected at each of the positions arranged in the radial direction of the optical disc, corresponding to each of the regions, into which the optical disc is divided in the radial direction, can be controlled with good accuracy. Consequently, the tilt angles corresponding to the positions arranged in the radial direction of an optical disc can be controlled with good precision.

In one embodiment, when definitively setting the tilt angle corresponding to one of the regions into which the optical disc is divided in the radial direction, in a case where the region, the tilt angle corresponding to which is provisional set, is present between the one of the regions, the tilt angle corresponding to which is definitively set, and the region, the tilt angle corresponding to which has already been definitively set, the setting unit updates the tilt angle provisionally set corresponding to the region that is present therebetween.

With this configuration, in a case where a region, the tilt angle corresponding to which is provisional set, is present between the one of the regions, the tilt angle corresponding to which is definitively set, and the region, the tilt angle corresponding to which has already been definitively set, the tilt angle provisionally set corresponding to this region is updated. For example, the tilt angle provisionally set corresponding to the region being present between these two regions, that is, the one of the regions, the tilt angle corresponding to which is definitively set, and the region, the tilt angle corresponding to which has already been definitively set, is updated by the first-order approximation using the tilt angle definitively set this time corresponding to the former region and the tilt angle having already been definitively set corresponding to the latter region. Thus, the tilt angle of the reading unit can be controlled with good precision even in the case of corresponding to the region, the tilt angle corresponding to which is provisionally set.

According to the invention, the optical disc apparatus can reduce the time required to become ready for starting to read and record data from and onto an optical disc after the optical disc is set therein. Users' operability can be enhanced. The tilt angle of the reading unit is detected at the seeking and at the temporary stop corresponding to the region, the tilt angle corresponding to which has been provisionally set. The tilt angle detected this time is definitively set corresponding to this region. Thus, the tilt angle of the reading unit, which is detected at each of the positions arranged in the radial direction of the optical disc, corresponding to each of the regions, into which the optical disc is divided in the radial direction, can be controlled with good accuracy. Consequently, the tilt angles corresponding to the positions arranged in the radial direction of an optical disc can be controlled with good precision.

### BRIEF DESCRIPTION OF THE DRAWINGS

FIG. 1 is a block diagram illustrating the configuration of a primary part of an optical disc apparatus according to an embodiment of the invention;

FIGS. 2A to 2C are diagrams illustrating a pickup head in the optical disc apparatus according to this embodiment;

FIG. 3 is an explanatory diagram illustrating detecting positions at which an appropriate tilt angle is detected;

FIG. 4 is a flowchart illustrating an operation at setting of an optical disc in the optical disc apparatus according to this embodiment;

FIG. 5 is a flowchart illustrating operations at seeking and at temporary stop of an optical disc in the optical disc apparatus according to this embodiment; and

FIG. 6 is a flowchart illustrating operations at reading of data and at recording of data in the optical disc apparatus according to this embodiment.

### DETAILED DESCRIPTION OF THE PREFERRED EMBODIMENTS

Hereinafter, an optical disc apparatus according to an embodiment of the invention is described.

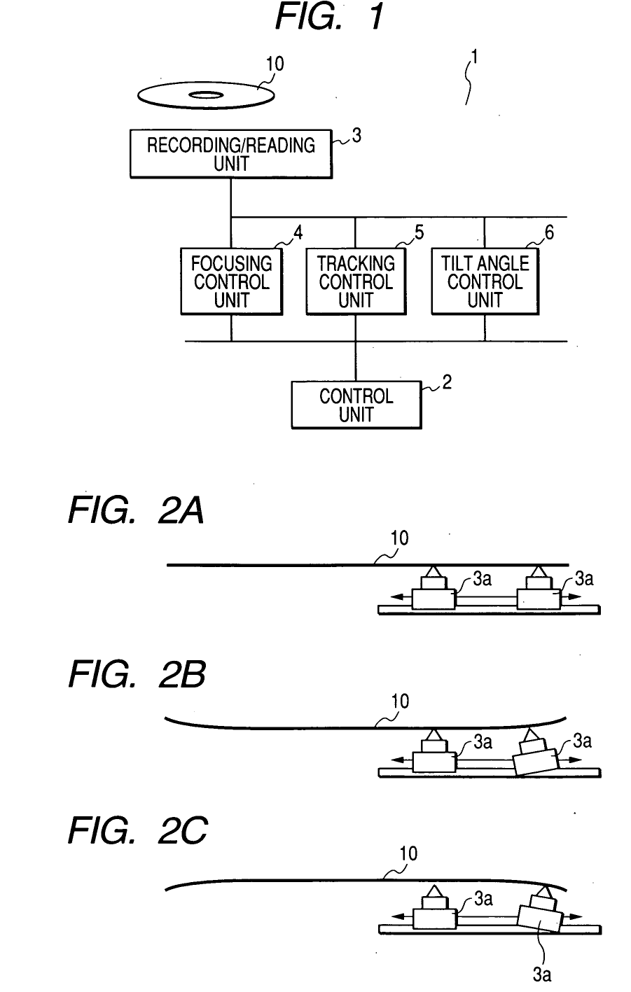

FIG. 1 is a block diagram showing the configuration of a primary part of the optical disc apparatus according to an embodiment of the invention. The optical disc apparatus 1 has a control unit 2 adapted to control a main body, and also has a recording/reading unit 3 adapted to irradiate laser light onto an optical disc 10, such as a CD or a DVD, set in the main body thereby to read data recorded thereon and to record data thereon, a focusing control unit 4 adapted to focus laser light onto a recording surface of the optical disc 10, a tracking control unit 5 adapted to perform a tracking control operation of tracking a laser light spot on the center of a track, and a tilt angle control unit 6 adapted to control a tilt angle of a pickup head 3a provided in the recording/reading unit 3.

The recording/reading unit 3 has the pickup head 3a. As shown in FIGS. 2A to 2C, the pickup head 3a is mounted on a shaft extending in a radial direction of the optical disc 10, and is moved along this shaft by a thread motor (not shown). Each of FIGS. 2A to 2C shows a total of two pickup heads 3a at the inner peripheral side and the outer peripheral side of the optical disc 10, respectively. However, actually, one pickup head 3a is mounted thereon. Additionally, the pickup head 3a is mounted thereon swingably with respect to a recording surface of the optical disc 10. Laser light irradiated from the pickup head 3a can be controlled by swinging the pickup head 3a so that the optical axis of the laser light becomes perpendicular to the recording surface of the optical disc 10. FIG. 2A shows a state in which the optical disc 10 has no warpage. Each of FIGS. 2A and 2B shows a state in which the optical disc 10 has warpage. The pickup head 3a is provided with LD (laser diode) serving as a light source device outputting laser light, an objective lens focusing the laser light outputted from the LD, a biaxial actuator adapted to move the objective lens in an approaching/separating direction, in which the objective lens approaches and separates from the optical disc 10, and in a radial direction of the optical disc 10, and PD (photo detector) that is a light receiving device adapted to detect reflection light reflected from the optical disc 10.

Incidentally, the description of this embodiments describes a configuration, in which the laser light irradiated from the pickup head 3a is controlled by swinging the pickup head 3a so that the optical axis of the laser light becomes perpendicular to the recording surface of the optical disc 10, by way of example. However, the apparatus may be configured so that the objective lens is swung instead of swing the main body of the pickup head 3a.

The focusing control unit 4 performs a control operation of moving the objective lens of the pickup head 3a in an approaching/separating direction, in which the objective lens approaches or is separated from the optical disc 10, according to FE (focusing error) signal outputted from the pickup head 3a to thereby focus laser light onto the recording surface of the optical disc 10. The focusing control unit 4 inputs a focusing servo signal, which is generated according to the FE signal, into the pickup head 3a (that is, the actuator operative to move the objective lens in the approaching/separating direction, in which the objective lens approaches or is separated from the optical disc 10). The tracking control unit 5 performs a control operation of moving the pickup head 3a or the objective lens thereof in a radial direction of the optical disc 10 according to TE (tracking error) signal outputted from the pickup head 3a to thereby track a laser light spot on the center of a reading track or a recording track. The tracking control unit 5 inputs a tracking servo signal, which is generated according to the TE signal, into the pickup head 3a (that is, the actuator operative to move the objective lens in the radial direction of the optical disc 10) or into the thread motor (not shown) adapted to move the pickup head 3a in the radial direction of the optical disc 10.

The tilt angle control unit 6 stores a tilt angle setting table 6a showing the corresponding relation among a tilt angle of the pickup head 3a, which corresponds to each of regions R1 to R10 obtained by dividing the optical disc 10 in the radial direction, a setting flag indicating which of a definitively set tilt angle and a provisionally set tilt angle the tilt angle of the pickup head 3a is, and the position in the radial direction of the optical disc 10, at which the definitively set tilt angle is detected. This table exemplifies a case where the optical disc 10 is divided into 10 regions arranged in the radial direction. The radial lengths of the regions R1 to R10 are equal to one another. When the optical disc 10 is set, the tilt angle control unit 6 detects an appropriate tilt angle at each of the center of the region R1 at the innermost peripheral side (that is, at the detecting position X1) and the center of the region R10 at the outermost peripheral side (that is, at the detecting position X10). The tilt angle control unit 6 changes the tilt angle of the pickup head 3a in stages within a predetermined range. An inclination angle of the pickup head 3a, which is measured when the RF signal has a maximum amplitude, is detected as an appropriate tilt angle at this position, and is definitively set in the tilt angle setting table 6a (that is, the setting flag is set at 1 indicating that this tilt angle is definitively set).

When the optical disc 10 is set, the tilt angle control unit 6 estimates tilt angles respectively corresponding to eight regions R2 to R9 other than the innermost peripheral region R1 and the outermost peripheral region R10 by performing a first-order approximation using the tilt angles respectively detected at the detecting position X1, which corresponds to the innermost peripheral region R1, and at the detecting position X10 corresponding to the outermost peripheral region R10. More specifically, let A1 and A10 designate an appropriate tilt angle detected at the detecting position X1, which corresponds to the innermost peripheral region R1, and an appropriate tilt angle detected at the detecting position X10, which corresponds to the outermost peripheral region R10. An appropriate tilt angle a at a position X in the radial direction of the optical disc 10 is estimated by the following equation:
a(X)=(X−X1)×(A10−A1)/(X10−X1)+A1
Alternatively, a(X)=(X−X10)×(A10−A1)/(X10−X1)+A10
Then, the coordinate value of the center of each of the eight regions R2 to R9 other than the innermost peripheral region R1 and the outermost peripheral region R10 is substituted for X, so that the tilt angle corresponding to each of the regions R2 to R9 is estimated. Further, the estimated tilt angle corresponding to each of the regions R2 to R9 is provisionally set in the tilt angle setting table 6a (that is, the setting flag is set at 0 indicating the provisional setting).

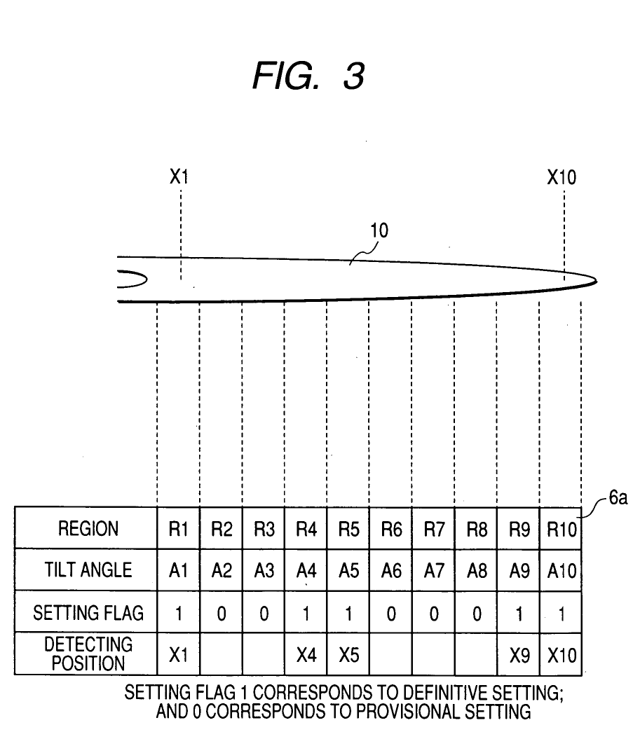

When the pickup head 3a seeks the region, the tilt angle corresponding to which is provisionally set, or when the pickup head temporally stops at the region, the tilt angle corresponding to which is provisionally set, the tilt angle control unit 6 detects an appropriate tilt angle of the pickup head 3a at a current position. The detection of the tilt angle is performed as follows. That is, as described above, the tilt angle of the pickup head is changed in stages within a predetermined range. Then, an inclination angle of the pickup head 3a, which is measured when the amplitude of the RF signal has a maximum value, is detected as an appropriate tilt angle, and is definitively set in the tilt angle setting table 6a. More specifically, the tilt angle corresponding to a target region, which is set in the tilt angle setting table 6a, is updated with a tilt angle detected this time. Further, a position (in the radial direction of the optical disc 10), at which the tilt angle is detected this time, is set therein as the detecting position. The value of the setting flag is changed to 1 indicating the definitive setting. In a case where one or more consecutive regions, the tilt angle corresponding to each of which is provisionally set, are present between the region, the tilt angle corresponding to which is definitively set this time, and the region, the tilt angle corresponding to which has already been definitively set, the tilt angle provisionally set corresponding to each of the consecutive regions is updated. More specifically, according to the first-order approximation using the tilt angle definitively set this time corresponding to a certain region and the tilt angles having already been definitively set corresponding to another certain region, tilt angles respectively corresponding to one or more regions, some tilt angles corresponding to which are provisionally set, between the certain regions are estimated. Then, the estimated tilt angles are provisionally set in the table shown in FIG. 3. For example, in a case that the region, the tilt angle corresponding to which is definitively set this time, is R5, that the tilt angles respectively corresponding to the regions R4 and R9 have been definitively set, and that the tilt angles corresponding to the regions R6 to R8 have been provisionally set, the tilt angles having been provisionally set corresponding to the regions R6 to R8 are updated. At that time, the tilt angle corresponding to each of the regions R6 to R8 is estimated and updated by the first-order approximation using the tilt angles, which have been definitively set corresponding to the regions R5 and R9, and also using the positions in the radial direction of the optical disc 10, at which these tilt angles are detected.

Incidentally, even in a case where the tilt angles respectively corresponding to the regions R2 and R3 are provisionally set, the tilt angle corresponding to the region R4 is definitively set. Thus, the provisionally set tilt angles respectively corresponding to these regions R2 and R3 are not updated.

Either a distance from the center of the optical disc 10 or an address may be used as data representing the detecting position, at which the tilt angle is detected, in the tilt angle setting table 6a. The tilt angle control unit 6 controls the tilt angle of the pickup head 3a according to the tilt angle setting table 6a when data is read from or recorded to the optical disc 10. More specifically, the pickup head 3a is controlled to be tilted at the tilt angle set corresponding to the region including a reading position at which data is read from the optical disc 10, or including a recording position at which data is recorded on the optical disc 10.

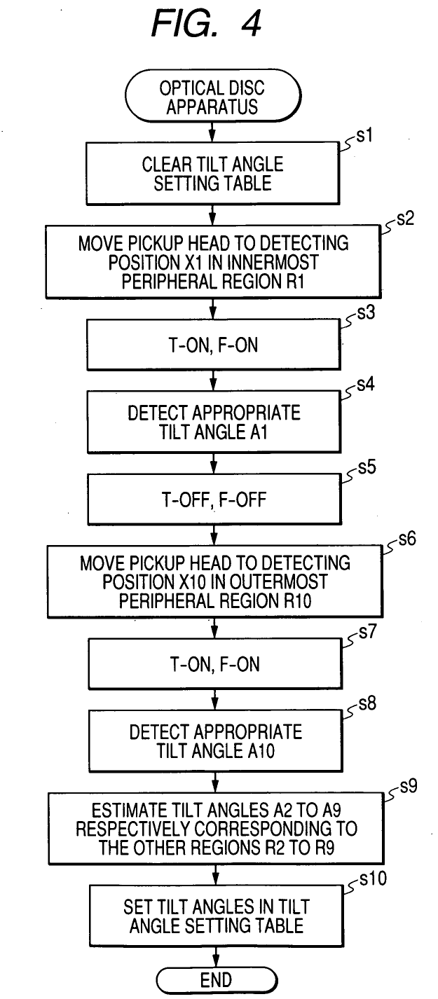

Hereinafter, an operation of the optical disc apparatus 1, which is the embodiment of the invention, is described. FIG. 4 is a flowchart illustrating an operation performed when an optical disc is set in the optical disc apparatus according to this embodiment. The optical disc apparatus 1 performs this operation when the optical disc 10 is set therein. In step s1, the optical disc apparatus 1 clears the tilt angle table 6a. Then, the optical disc apparatus 1 moves the pickup head 3a to the detecting position X1 in the innermost peripheral region R1 of the optical disc 10 in step s2. Subsequently, in step s3, a tracking servo under the control of the tracking control unit 5 is put into an on-mode. Also, a focusing servo under the control of the focusing servo control unit 4 is brought into an on-mode. Then, in step s4, the tilt angle control unit 6 detects an appropriate tilt angle A1 at this detecting position X1. In step s4, the pickup head 3a is inclined in stages within a predetermined range. A tilt angle of the pickup head 3a, which is measured when the amplitude of the RF signal has a maximum value, is detected as the appropriate tilt angle A1 at the detecting position X1.

When the optical disc apparatus 1 detects the appropriate tilt angle A1 at the detecting position X1, the tracking servo control unit 5 turns off the tracking servo, and the focusing servo control unit 6 turns off the focusing servo in step s5. Then, the pickup head 3a is moved to the detecting position X10 in the outermost peripheral region R1 of the optical disc 10 in step s6. Subsequently, in step s7, the tracking servo under the control of the tracking control unit 5 is put into an on-mode. Also, the focusing servo under the control of the focusing servo control unit 4 is brought into an on-mode. Then, in step s8, the tilt angle control unit 6 detects an appropriate tilt angle A10 at this detecting position X10. In step s8, the pickup head 3a is inclined in stages within the predetermined range. A tilt angle of the pickup head 3a, which is measured when the signal level of the RF signal has a maximum value, is detected as the appropriate tilt angle A10 at the detecting position X10.

In step s9, the optical disc apparatus 1 estimates an appropriate tilt angle corresponding to each of the eight regions R2 to R9 other than the innermost peripheral region R1 and the outermost peripheral region R10. In step s9, the appropriate tilt angles corresponding to the positions arranged in the radial direction of the optical disc 10 are estimated by the first-order approximation using the appropriate tilt angles A1 and A10 that are detected at the detecting positions X1 and X10 in steps S4 and s8, respectively. More specifically, the appropriate tilt angle a(X) at the position X in the radial direction of the optical disc 10 is estimated by the following equation:
a(X)=(X−X1)×(A2−A1)/(X2−X1)+A1
Then, the coordinate value of the center of each of the eight regions R2 to R9 other than the innermost peripheral region R1 and the outermost peripheral region R10 is substituted for X, so that the tilt angles A2 to A9 respectively corresponding to the regions R2 to R9 are estimated.

When the tilt angle control unit 6 estimates the tilt angles A2 to A9 respectively corresponding to the regions R2 to R9, the optical disc apparatus 1 sets the tilt angles A1 to A10 respectively corresponding to the regions R1 to R10 in step s10. Thus, this operation is finished. In step s10, the tilt angles A1 and A10 respectively corresponding to the regions R1 and R2, which are detected in steps s5 and s9, are definitively set (that is, the setting flag is set at 1 indicating the definitive setting). Meanwhile, the tilt angles respectively corresponding to the regions R2 to R9, which are estimated in step s9, are provisionally set. The setting flag corresponding to each of the regions R2 to R9 is set at 0 indicating the provisional setting.

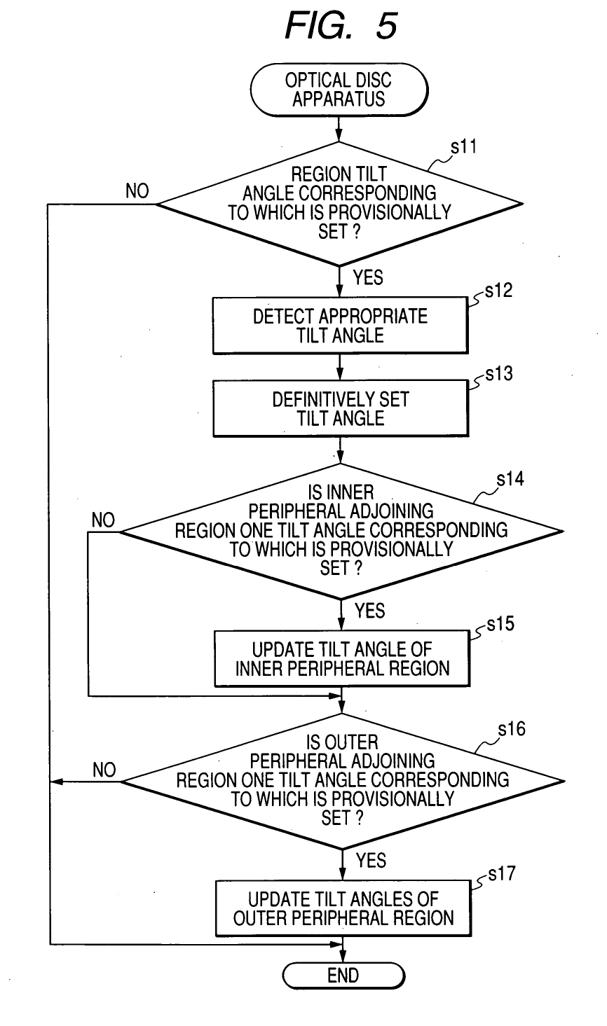

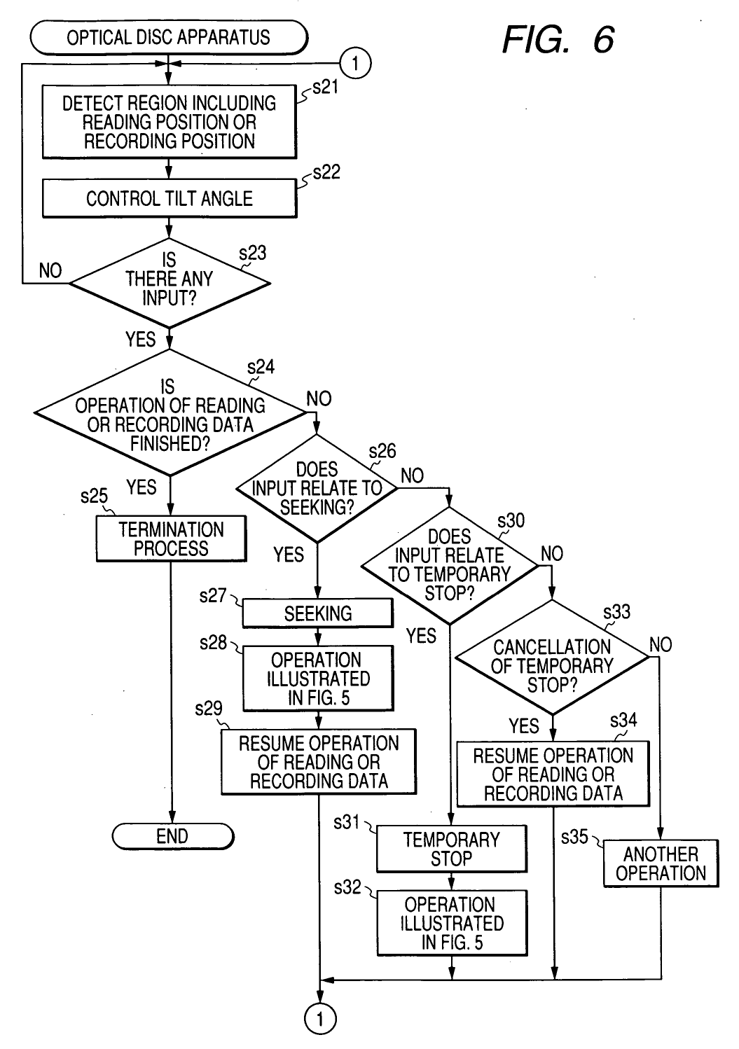

Next, an operation, which is performed when the optical disc apparatus 1 performs seeking or when the optical disc apparatus 1 temporarily stops (or pauses), is described hereinbelow. FIG. 5 is a flowchart illustrating this operation. The optical disc apparatus 1 determines in step s11 whether the position, at which the apparatus 1 performs seeking or temporarily stops, is in the region, the tilt angle corresponding to which is provisionally set. If the optical disc apparatus 1 determines that this position is in the region, the tilt angle corresponding to which is not provisionally set, this operation is finished. Conversely, if the optical disc apparatus 1 determines that this position is in the region, the tilt angle corresponding to which is provisionally set, an appropriate tilt angle of the pickup head 3a is detected in step s12 at the position, at which the apparatus 1 performs seeking or temporarily stops. Then, in step s13, the tilt angle corresponding to the associated region is definitively set in the tilt angle setting table 6a. In step s13, the tilt angle corresponding to the associated region in this tilt angle setting table 6a is updated with the tilt angle detected this time. Also, the setting flag is updated with 1 indicating the definitive setting. Moreover, the position in the radial direction of the optical disc, at which the tilt angle is detected this time, is set as the detecting position.

Upon completion of a process to be performed in step s13, the optical disc apparatus 1 determines in step s14 whether the inner peripheral region adjoining the region, the tilt angle corresponding to which is definitively set this time, is the region, the tilt angle corresponding to which is provisionally set. If the adjoining inner peripheral region is the region, the tilt angle corresponding to which is provisionally set, one or more consecutive inner peripheral regions are present between the region, the tilt angle corresponding to which is definitively set this time, and the region, the tilt angle corresponding to which has already been definitively set. If the optical disc apparatus 1 determines in step s14 that the adjoining inner peripheral region is the region, the tilt angle corresponding to which is provisionally set, the tilt angles corresponding to the one or more consecutive inner peripheral regions, which are present between the region, the tilt angle corresponding to which is definitively set this time, and the region, the tilt angle corresponding to which has already been definitively set, are updated in step s15. The tilt angles corresponding to the one or more consecutive inner peripheral regions, which are present therebetween, are estimated by the first-order approximation using the tilt angles corresponding to the region, the tilt angle corresponding to which is definitively set this time, and the region, the tilt angle corresponding to which has already been definitively set, in step s15. Also, the optical disc apparatus 1 updates the tilt angles set in the tilt angle setting table 6a with the tilt angles estimated this time. The estimation of the tilt angles in step s15 is performed according to the method described in the description of step s9. Incidentally, the detecting positions, at which the tilt angles to be used in the first-order approximation are respectively detected, are different from those in the case of that method.

If the optical disc apparatus 1 determines in step s14 that the adjoining inner peripheral region is the region, the tilt angle corresponding to which is provisionally set, the optical disc apparatus 1 determines in step s16, upon completion of the process to be performed in step s15, that the outer peripheral region adjoining the region, the tilt angle corresponding to which is definitively set, is the region, the tilt angle corresponding to which is provisionally set. If the adjoining outer peripheral region is the region, the tilt angle corresponding to which is provisionally set, one or more consecutive outer peripheral regions are present between the region, the tilt angle corresponding to which is definitively set this time, and the region, the tilt angle corresponding to which has already been definitively set. If the optical disc apparatus 1 determines in step s16 that the adjoining outer peripheral region is the region, the tilt angle corresponding to which is provisionally set, the tilt angles corresponding to the one or more consecutive outer peripheral regions, which are present between the region, the tilt angle corresponding to which is definitively set this time, and the region, the tilt angle corresponding to which has already been definitively set, are updated in step s17. The tilt angles corresponding to the one or more consecutive outer peripheral regions, which are present therebetween, are estimated by the first-order approximation using the tilt angles corresponding to the region, the tilt angle corresponding to which is definitively set this time, and the region, the tilt angle corresponding to which has already been definitively set, in step s17, similarly to step 15. Also, the optical disc apparatus 1 updates the tilt angles set in the tilt angle setting table 6a with the tilt angles estimated this time in step s17. The estimation of the tilt angles in step s17 is performed according to the method described in the descriptions of steps s9 and s15. Incidentally, the detecting positions, at which the tilt angles to be used in the first-order approximation are respectively detected, are different from those in the case of that method. Upon completion of the process performed in step s17, the optical disc apparatus 1 finishes this operation.

FIG. 6 is a flowchart illustrating operations at reading of data and at recording of data in the optical disc apparatus according to this embodiment. The optical disc apparatus 1 detects the region including a reading position, at which data is read from the optical disc 10, and a recording position, at which data is recorded onto the optical disc 10, in step s21. Then, in step s22, the pickup head 3a is inclined at the tilt angle set corresponding to the detected region in the table shown in FIG. 3. Subsequently, the optical disc apparatus 1 checks the presence/absence of input to the main body thereof in step s23. If there is no input thereto, this operation returns to step s21.

If there is an input thereto, and if this input relates to the termination of reading data or of recording data, the optical disc 1 terminates the reading of data or the recording of data in steps s24 and s25. Thus, the optical disc apparatus 1 finishes this operation. If the input relates to the seeking, the optical disc apparatus performs seeking in steps s26 and s27. Subsequently, in step s28, the optical disc apparatus performs the process illustrated in FIG. 5. Then, an operation relating to the reading or recording of data is resumed from the position, at which the seeking has been performed, in step s29. If the input relates to the temporary stop, the optical disc apparatus 1 stops the operation relating to the reading or recording of data in steps s30 and s31. Thereafter, the process illustrated in FIG. 5 is performed in step s32. Then, the operation returns to step s21. Further, if the input relates to the cancellation of the temporary stop, the optical disc apparatus 1 resumes the operation relating to the reading or recording of data in steps s33 and s34.

Incidentally, if the input relating to another operation, the optical disc apparatus 1 performs this operation according to the input in step s35.

Thus, the optical disc apparatus 1 according to this embodiment is adapted so that when the optical disc 10 is set therein, the tilt angles A1 and A10 of the pickup head 3a are detected at the detecting position X1 determined in the innermost peripheral region R1 and the detecting position X10 determined in the outermost peripheral region R10, respectively. The tilt angles A2 to A9 respectively corresponding to the positions arranged in the radial direction of the optical disc 10 are estimated and are provisionally set corresponding to the regions R2 to R9 by the first-order approximation using the appropriate tilt angles A1 and A10 detected at the detecting positions X1 and X10, respectively. Thus, the optical disc apparatus can reduce the time required to become ready for starting to read and record data from and onto an optical disc after the optical disc is set therein. Regarding the regions, the tilt angles corresponding to which are provisionally set, the tilt angles are newly detected at the seeking or at the temporary stop and are definitively set. Consequently, the tilt angle of the pickup head 3a corresponding to each of the regions R1 to R10 can be controlled with good accuracy. When a tilt angle is definitively set corresponding to a region the tilt angle corresponding to which has been provisionally set, the tilt angles provisionally set corresponding to one or more consecutive regions being present between the region, the tilt angle corresponding to which is definitively set this time, and the region, the tilt angle corresponding to which the tilt angle has already been definitively set, are updated. Thus, a tilt angle of the pickup head 3a can be controlled with good accuracy even in the regions, the tilt angles corresponding to which are provisionally set.

Although the tilt angle, which is measured when the amplitude of the RF signal has a maximum value, is detected as the appropriate tilt angle in the aforementioned embodiment, the tilt angle, which is measured when the amplitude of the TE signal has a maximum value, may be detected as the appropriate tilt angle. The tilt angle of the pickup head 3a, which is measured when the amplitude of the RF signal has a maximum value, is substantially equal to that of the pickup head 3a, which is measured when the amplitude of the TE signal has a maximum value. In this case, an appropriate tilt angle is estimated in a state in which a tracking control operation to be performed by the tracking control unit 5 is put into an off-mode.

According to this method of estimating an appropriate tilt angle corresponding to the position in the radial direction of the optical disc 10 according to the amplitude of the TE signal, the estimation can appropriately be performed even in the case of using an optical disc 10 in which no data is recorded at ach of the detecting positions X1 and X2, so that no amplitude of the RF signal is obtained.

Although the tilt angle, which is measured when the amplitude of the RF signal has a maximum value, is detected in the aforementioned embodiment, the optical disc apparatus may detect a tilt angle, which is measured when the amplitude of reflection light obtained by reflecting a sub-beam, which is generated from laser light irradiated from LD by using a diffraction grating, has a maximum value.

What is claimed is:

1. An optical disc apparatus comprising:
reading means for reading data recorded on an optical disc set in a main body of the optical disc apparatus by irradiating laser light onto the optical disc;
tilt-angle detecting means for detecting a tilt angle of the reading means with respect to the optical disc set in the main body;
setting means for detecting, when the optical disc is set, the tilt angle of the reading means at a plurality of predetermined detecting positions arranged in a radial direction of the optical disc, and setting the tilt angle of the reading means, which corresponds to each of the positions arranged in the radial direction of the set optical disc; and
tilt-angle control means for controlling the tilt angle of the reading means according to the tilt angle set corresponding to a reading position, at which the reading means reads data from the optical disc, by the setting means;
wherein when the optical disc is set, the tilt angles of the reading means are detected by the tilt angle detecting means at two detecting positions respectively predetermined at an inner peripheral side and an outer peripheral side of the optical disc;
the setting means definitively sets the detected tilt angles corresponding to regions, in which the detecting positions respectively predetermined at the inner peripheral side and the outer peripheral side are present, among a plurality of regions, into which the optical disc is divided in the radial direction thereof;
the setting means provisionally sets the tilt angle corresponding to each of the other regions according the tilt angles detected by the tilt angle detecting means at the detecting positions at the inner peripheral side and the outer peripheral side, respectively;
when seeking the region, the tilt angle corresponding to which is provisionally set, or when temporarily stopped in the region, the tilt angle corresponding to which is provisionally set, a tilt angle of the reading means is detected at a seeking position or at a temporary stop position by the tilt angle detecting means; and
the setting means definitively sets the tilt angle detected at the seeking position corresponding to the sought region or at the temporary stop position corresponding to the region in which the reading means is temporarily stopped.

2. An optical disc apparatus comprising:
a reading unit adapted to read data recorded on an optical disc set in a main body of the optical disc apparatus by irradiating laser light onto the optical disc;
a tilt-angle detecting unit adapted to detect a tilt angle of the reading unit with respect to the optical disc set in the main body;
a setting unit adapted to detect, when the optical disc is set, the tilt angle of the reading unit at a plurality of predetermined detecting positions arranged in a radial direction of the optical disc, and adapted to set the tilt angle of the reading unit, which corresponds to each of the positions arranged in the radial direction of the set optical disc; and
a tilt-angle control unit adapted to control the tilt angle of the reading unit according to the tilt angle set corresponding to a reading position, at which the reading unit reads data from the optical disc, by the setting unit;
wherein when the optical disc is set, tilt angles of the reading unit are detected by the tilt angle detecting unit at two detecting positions respectively predetermined at an inner peripheral side and an outer peripheral side of the optical disc;
the setting unit definitively sets the detected tilt angle corresponding to regions, in which the detecting positions respectively predetermined at the inner peripheral side and the outer peripheral side are present, among a plurality of regions, into which the optical disc is divided in the radial direction thereof;
the setting unit provisionally sets the tilt angle corresponding to each of the other regions according the tilt angles detected by the tilt angle detecting unit at the detecting positions at the inner peripheral side and the outer peripheral side, respectively;
when seeking the region, the tilt angle corresponding to which is provisionally set, the tilt angle of the reading unit is detected at a seeking position by the tilt angle detecting unit; and
the setting unit definitively sets the tilt angle detected at the seeking position corresponding to the sought region.

3. An optical disc apparatus having:
a reading unit adapted to read data recorded on an optical disc set in a main body of the optical disc apparatus by irradiating laser light onto the optical disc;
a tilt-angle detecting unit adapted to detect a tilt angle of the reading unit with respect to the optical disc set in the main body;
a setting unit adapted to detect, when the optical disc is set, a tilt angle of the reading unit at a plurality of predetermined detecting positions arranged in a radial direction of the optical disc, and adapted to set the tilt angle of the reading unit, which corresponds to each of the positions arranged in the radial direction of the set optical disc; and
a tilt-angle control unit adapted to control the tilt angle of the reading unit according to the tilt angle set corresponding to a reading position, at which the reading unit reads data from the optical disc, by the setting unit;
wherein when the optical disc is set, the tilt angles of the reading unit are detected by the tilt angle detecting unit at two detecting positions respectively predetermined at an inner peripheral side and an outer peripheral side of the optical disc;
the setting unit definitively sets the detected tilt angle corresponding to regions, in which the detecting positions respectively predetermined at the inner peripheral side and the outer peripheral side are present, among a plurality of regions, into which the optical disc is divided in the radial direction thereof;
the setting unit provisionally sets the tilt angle corresponding to each of the other regions according the tilt angles detected by the tilt angle detecting unit at the detecting positions at the inner peripheral side and the outer peripheral side, respectively;
when temporarily stopped in the region, the tilt angle corresponding to which is provisionally set, the tilt angle of the reading unit is detected at a temporary stop position by the tilt angle detecting unit; and
the setting unit definitively sets the tilt angle detected at the temporary stop position corresponding to the region in which the reading unit is temporarily stopped.

4. The optical disc apparatus according to claim 2, wherein when definitively setting the tilt angle corresponding to one of the regions into which the optical disc is divided in the radial direction, in a case where the region, the tilt angle corresponding to which is provisional set, is present between the one of the regions, the tilt angle corresponding to which is definitively set, and the region, the tilt angle corresponding to which has already been definitively set, the setting unit updates the tilt angle provisionally set corresponding to the region that is present therebetween.

5. The optical disc apparatus according to claim 3, wherein when definitively setting the tilt angle corresponding to one of the regions into which the optical disc is divided in the radial direction, in a case where the region, the tilt angle corresponding to which is provisional set, is present between the one of the regions, the tilt angle corresponding to which is definitively set, and the region, the tilt angle corresponding to which has already been definitively set, the setting unit updates the tilt angle provisionally set corresponding to the region that is present therebetween.
